(19) United States
(12) Patent Application Publication
(10) Pub. No.: US 2026/0029381 A1
(43) Pub. Date: Jan. 29, 2026

(54) LASER ULTRASONIC INSPECTION APPARATUS

(71) Applicant: SEIKO EPSON CORPORATION, TOKYO (JP)

(72) Inventor: Kohei YAMADA, SHIOJIRI-SHI (JP)

(21) Appl. No.: 19/281,806

(22) Filed: Jul. 28, 2025

(30) Foreign Application Priority Data
Jul. 29, 2024 (JP) 2024-121978

(51) Int. Cl. G01N 29/24; G01N 29/04; G01N 29/26

(52) U.S. Cl. CPC G01N 29/2418; G01N 29/043; G01N 29/26; G01N 2291/02854; G01N 2291/0289

(57) ABSTRACT

A laser ultrasonic inspection apparatus includes a first laser light source, and a laser interferometer configured to use a second laser beam to detect a vibration of the target, wherein the laser interferometer includes a second laser light source configured to irradiate the target with the second laser beam, a light modulator configured use a vibrator to modulate a frequency of the second laser beam, a photodetector configured to receive the second laser beam from the light modulator and the second laser beam from the target to output a light reception signal, and a signal processor configured to detect the vibration based on the light reception signal and a reference signal, and measure, based on the reference signal, an elapsed time from the first laser light source emits the first laser beam to the vibration is detected, and the vibrator is a signal source of the reference signal.

The present application is based on, and claims priority from JP Application Serial Number 2024-121978, filed Jul. 29, 2024, the disclosure of which is hereby incorporated by reference herein in its entirety.

### BACKGROUND

### 1. Technical Field

The present disclosure relates to a laser ultrasonic inspection apparatus.

### 2. Related Art

JP-A-04-147053 discloses a laser ultrasonic flaw detection method in which a reflective vibrating plate is irradiated with a pulsed ultrasonic generating laser beam to generate an ultrasonic wave in the reflective vibrating plate, the ultrasonic wave thus generated is transmitted to a target, an ultrasonic wave reflected from a location of a flaw in the target is received by a reflective vibrating plate, and a vibration of the reflective vibrating plate which occurs at this moment is detected with an ultrasonic detecting laser beam.

Further, JP-A-09-281085 discloses that, in a laser ultrasonic inspection apparatus, a target is irradiated with a laser beam to generate an ultrasonic wave, and a vibration of the target due to the ultrasonic wave thus generated is detected by a laser interferometer. According to such a laser ultrasonic inspection apparatus, it is possible to improve the distance resolution when determining a position of a flaw of the target.

JP-A-04-147053 and JP-A-09-281085 are examples of the related art.

In the laser ultrasonic inspection apparatus described in JP-A-09-281085, it is necessary to precisely observe a time from the irradiation with the laser beam to when the ultrasonic wave is detected in the identification of the position of the flaw with the laser interferometer. JP-A-09-281085 does not describe a method of observing that time. In addition, a technique of detecting the presence or absence of a flaw by calculating the frequency of the vibration is also known, but in this case as well, it is necessary to observe the time described above.

In general, a reference signal (clock signal) is used to measure time. A signal generator is used to generate the reference signal, but the use of the signal generator increases the number of components of the laser ultrasonic inspection apparatus to hinder a reduction in size.

Therefore, it is an object to realize a laser ultrasonic inspection apparatus that is small in the number of components and is easy to reduce in size.

### SUMMARY

A laser ultrasonic inspection apparatus according to an application example of the present disclosure includes a first laser light source configured to irradiate a target with a first laser beam as a pulsed beam, and
a laser interferometer configured to use a second laser beam to detect a vibration of the target derived from ultrasonic waves induced in the target by irradiation with the first laser beam, wherein
the laser interferometer includes
a second laser light source configured to irradiate the target with the second laser beam,
a light modulator configured use a vibrator to modulate a frequency of the second laser beam,
a photodetector configured to receive the second laser beam passed through the light modulator and the second laser beam passed through the target to output a light reception signal, and
a signal processor configured to detect the vibration based on the light reception signal and a reference signal, and measure, based on the reference signal, an elapsed time from when the first laser light source emits the first laser beam to when the vibration is detected, and
the vibrator is a signal source of the reference signal.

A laser ultrasonic inspection apparatus according to an application example of the present disclosure includes
a first laser light source configured to irradiate a target with a first laser beam as a pulsed beam, and
a laser interferometer configured to use a second laser beam to detect a vibration of the target derived from ultrasonic waves induced in the target by irradiation with the first laser beam, wherein
the laser interferometer includes
a second laser light source configured to irradiate the target with the second laser beam,
a light modulator configured use a vibrator to modulate a frequency of the second laser beam,
a photodetector configured to receive the second laser beam passed through the light modulator and the second laser beam passed through the target to output a light reception signal, and
a signal processor configured to detect the vibration based on the light reception signal and a reference signal, and calculate a frequency of the vibration based on the reference signal, and
the vibrator is a signal source of the reference signal.

### BRIEF DESCRIPTION OF THE DRAWINGS

FIG. 1 is a block diagram showing a general configuration of a laser ultrasonic inspection apparatus according to a first embodiment.

FIG. 2 is a timing chart showing an example of a reference signal, a displacement calculated from a light reception signal, and a laser detection signal input to a signal processor.

FIG. 3 is a schematic diagram showing propagation of an ultrasonic wave induced by first laser beams with which two different places are respectively irradiated, defining two axes orthogonal to each other in a surface of a target as an X axis and a Y axis, and an axis in a depth direction as a Z axis.

FIG. 4 is a block diagram showing a general configuration of a laser ultrasonic inspection apparatus according to a second embodiment.

FIG. 5 is an example of a circuit diagram of a frequency converter including an n-ary counter.

FIG. 6 is a block diagram showing a general configuration of a laser ultrasonic inspection apparatus according to a third embodiment.

FIG. 7 is a diagram showing an example of a scanning trajectory of the irradiation position with the first laser beam and an example of image data obtained by replacing the length of an elapsed time at each position with a color density and mapping the color density, in an orthogonal coordinate system configured with the X axis and the Y axis set in the target.

FIG. 8 is a block diagram showing a general configuration of a laser ultrasonic inspection apparatus according to a fourth embodiment.

FIG. 9 is a diagram showing an example of a scanning trajectory of the irradiation position with the first laser beam in an orthogonal coordinate system configured with the X axis and the Y axis set to the target.

FIG. 10 is a schematic diagram showing a general configuration of a laser ultrasonic inspection apparatus according to a fifth embodiment.

FIG. 11 is a schematic diagram showing a general configuration of a laser ultrasonic inspection apparatus according to a sixth embodiment.

FIG. 12 is a graph showing a waveform of a displacement of a target with the vibration.

FIG. 13 is a diagram showing an example of a scanning trajectory of the irradiation position with the first laser beam and an example of image data obtained by replacing the intensity as the frequency analysis result at each position with the color density and mapping the color density in the orthogonal coordinate system configured with the X axis and the Y axis set in the target.

FIG. 14 is a block diagram showing a general configuration of a laser ultrasonic inspection apparatus in related art.

### DESCRIPTION OF EMBODIMENTS

A laser ultrasonic inspection apparatus according to the present disclosure will hereinafter be described in detail based on some embodiments shown in the accompanying drawings.

### 1. Related Art

First, the related art will be described.

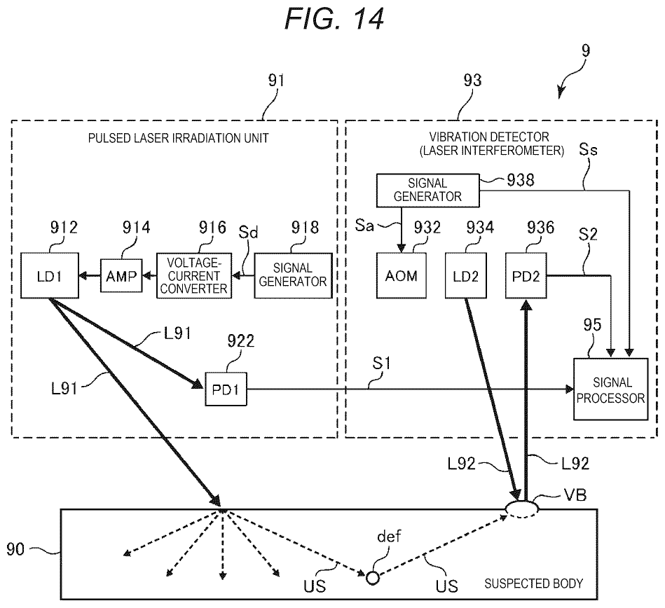

FIG. 14 is a block diagram showing a general configuration of a laser ultrasonic inspection apparatus 9 in the related art.

The laser ultrasonic inspection apparatus 9 illustrated in FIG. 14 includes a pulsed laser irradiation unit 91 and a vibration detector 93 (laser interferometer).

The pulsed laser irradiation unit 91 includes a laser light source 912, an amplifier 914, a voltage-current converter 916, a signal generator 918, and a photodiode 922.

The signal generator 918 generates a pulse control signal Sd. The voltage-current converter 916 converts the pulse control signal Sd, which is a pulsed voltage signal, into a current signal. The amplifier 914 amplifies the current signal and then supplies the current signal to the laser light source 912. Then, the pulsed laser irradiation unit 91 irradiates a target 90 with the laser beam L91 emitted from the laser light source 912. As a result, an ultrasonic wave US is induced in the target 90. The ultrasonic wave US thus generated propagates in the target 90, and when there is a flaw def in the target 90, the ultrasonic wave US is reflected there and reaches a surface. The ultrasonic wave US that has reached the surface induces a vibration VB of the surface. Further, the photodiode 922 receives a part of the laser beam L91 and generates a laser detection signal S1.

The vibration detector 93 is a laser interferometer, and includes an acousto-optical modulator (AOM) 932, a laser light source 934, a photodiode 936, a signal generator 938, and a signal processor 95.

The signal generator 938 generates a drive signal Sa necessary for an operation of the acousto-optical modulator 932 and a reference signal Ss serving as a time reference for signal processing in the signal processor 95. The vibration detector 93 irradiates the target 90 with the laser beam L92 emitted from the laser light source 934. Accordingly, the laser beam L92 is subjected to a Doppler shift due to the vibration VB of the surface. Then, the photodiode 936 receives the laser beam L92 subjected to the Doppler shift and the laser beam L92, which has passed through the acousto-optical modulator 932, and outputs a light reception signal S2. The vibration VB is electrically detected by measuring the Doppler shift using the interference effect of light.

Based on the laser detection signal S1 output from the photodiode 922, the light reception signal S2 output from the photodiode 936, and the reference signal Ss output from the signal generator 938, the signal processor 95 calculates an elapsed time Δt from when the laser beam L91 is emitted to when the vibration VB is detected. A position of a reflection point is reflected on the elapsed time Δt. The signal processor 95 determines the presence or absence and the position of the flaw def based on the elapsed time Δt.

However, the signal generator 938 provided to the vibration detector 93 causes an increase in the number of components of the laser ultrasonic inspection apparatus 9. In particular, a light modulator such as the acousto-optical modulator 932 (AOM) or an electro-optical modulator (EOM) (not shown) is large in size of its own and is high in power consumption. Therefore, an increase in the number of components and an increase in the size of the signal generator 938 that supplies the drive signal Sa to these components are inevitable, and it is difficult to reduce the size of the laser ultrasonic inspection apparatus 9 in the related art.

Therefore, in a first embodiment described later, by providing a light modulator using a vibrator, a reduction in the number of components, a reduction in size, a reduction in power consumption, and so on of the vibration detector (laser interferometer) are achieved. Accordingly, it is possible to realize a laser ultrasonic inspection apparatus easy to reduce in size and excellent in portability.

### 2. First Embodiment

Then, a laser ultrasonic inspection apparatus according to a first embodiment will be described.

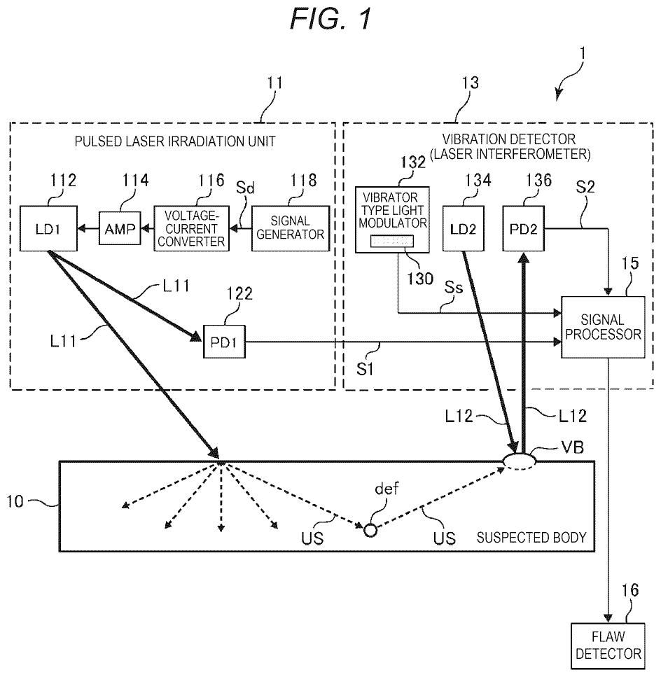

FIG. 1 is a block diagram illustrating a general configuration of the laser ultrasonic inspection apparatus 1 according to the first embodiment.

The laser ultrasonic inspection apparatus 1 illustrated in FIG. 1 includes a pulsed laser irradiation unit 11, a vibration detector 13 (laser interferometer), and a flaw detector 16.

The pulsed laser irradiation unit 11 includes a first laser light source 112, an amplifier 114, a voltage-current converter 116, a signal generator 118, and a photodiode 122. The pulsed laser irradiation unit 11 irradiates a target 10 with the first laser beam L11 as a pulsed beam emitted from the first laser light source 112. As a result, the ultrasonic wave US is induced in the target 10. The ultrasonic wave US thus generated propagates radially in the target 10, and when there is a flaw def in the target 10, the ultrasonic wave US is reflected there and reaches the surface. The ultrasonic wave US that has reached the surface induces the vibration VB accompanied by a displacement of the surface.

The vibration detector 13 is a laser interferometer, and includes a light modulator 132 using a vibrator 130, a second laser light source 134, a photodiode 136 (photodetector), and a signal processor 15. The vibration detector 13 irradiates the target 10 with a second laser beam L12 emitted from the second laser light source 134. Accordingly, the second laser beam L12 is subjected to the Doppler shift due to the vibration VB of the surface. Then, the second laser beam L12 subjected to the Doppler shift is received by the photodiode 136. The vibration VB is electrically detected by measuring the Doppler shift using the interference effect of the second laser beam L12.

Specifically, the second laser beam L12 emitted from the second laser light source 134 is split into two beams by, for example, a light splitter (not shown), one of the beams is incident on the light modulator 132, and the other is incident on the target 10. In the light modulator 132, the frequency of the second laser beam L12 is modulated, and reference light including a modulation signal is generated. Further, in the target 10, the second laser beam L12 is subjected to the Doppler shift, and the object light including the surface vibration signal is generated. The reference light and the object light are made to interfere with each other and to be received by the photodiode 136. Accordingly, the light reception signal S2 including the modulation signal and the surface vibration signal is output from the photodiode 136. In the signal processor 15, the surface vibration signal is demodulated from the light reception signal S2, and the displacement and displacement speed of the surface of the target 10 are calculated.

The light modulator 132 applies a modulation signal to the second laser beam L12 using the vibration of the vibrator 130, and generates the reference signal Ss using the vibrator 130 as a signal source. The light modulator 132 includes a vibrator oscillation circuit (not shown) that oscillates the vibrator 130. Since the vibrator oscillation circuit can be configured with a small number of components, the reference signal Ss can be generated while avoiding a significant increase in the number of components. Further, since the oscillation of the vibrator 130 can be performed at a low voltage, the power consumption of the vibrator oscillation circuit can be suppressed to a low level. Therefore, the laser ultrasonic inspection apparatus 1 can operate with an internal power supply such as a primary battery or a secondary battery besides an external power supply.

Based on the laser detection signal S1 output from the photodiode 122, the light reception signal S2 output from the photodiode 136, and the reference signal Ss output from the light modulator 132, the signal processor 15 calculates the elapsed time Δt from when the first laser beam L11 is emitted to when the vibration VB is detected.

The flaw detector 16 detects the presence or absence of the flaw def and obtains the position of the flaw def based on the elapsed time Δt. This makes it possible to inspect the target 10.

In such a laser ultrasonic inspection apparatus 1, the light modulator 132 using the vibrator 130 is provided to the vibration detector 13. In the light modulator 132, by irradiating the vibrator 130 which is vibrating with the second laser beam L12, a modulation signal is provided to the second laser beam L12, and the reference light is generated. Further, the vibrator 130 is also used as a signal source of the reference signal Ss. Therefore, by using the vibrator 130, it is possible to obtain the laser ultrasonic inspection apparatus 1 that is easy to reduce in size and excellent in portability.

Each part of the laser ultrasonic inspection apparatus 1 will hereinafter be described in detail.

### 2.1. Pulsed Laser Irradiation Unit

The pulsed laser irradiation unit 11 illustrated in FIG. 1 emits, toward the target 10, the first laser beam L11 as a pulsed beam having a predetermined repetition frequency. Further, a part of the first laser beam L11 thus emitted is received by the photodiode 122 to detect the emission timing.

The first laser light source 112 emits first laser beam L11 as a pulsed beam. Examples of the first laser light source 112 include Nd:YAG laser, CO₂ laser, Er:YAG laser, titanium sapphire laser, alexandrite laser, ruby laser, dye laser, fiber laser, excimer laser, and semiconductor laser. Among these, the semiconductor laser is preferably used. The semiconductor laser can make a contribution to a reduction in size, a reduction in weight, and a reduction in power consumption of the first laser light source 112. Further, the semiconductor laser can easily perform pulse oscillation by direct modulation, and can emit the first laser beam L11 as a pulsed beam at low cost. In addition, the semiconductor laser may have a metal package such as a CAN package, a ceramic package, or the like that houses an element as needed.

The repetition frequency of the first laser beam L11 as a pulsed beam is not particularly limited, but is preferably 1 Hz or more and 1000 Hz or less.

The pulse energy of the first laser beam L11 as a pulsed beam is appropriately set in accordance with the material or the like of the target 10 and is not particularly limited, but is preferably 1 μJ/pulse or more, and more preferably 10 μJ/pulse or more and 10 J/pulse or less. Further, when the target 10 is a hard object such as a concrete mass or a metal mass, it is preferable to select high pulse energy of about 1 mJ/pulse, and when the target 10 is a soft object such as resin, it is preferable to select low pulse energy of about 1 μJ/pulse.

The amplifier 114 amplifies a current signal to be supplied to the first laser light source 112. Note that the amplifier 114 may be provided as needed, and may be omitted when amplification is not necessary in driving the first laser light source 112.

The voltage-current converter 116 converts the voltage signal output from the signal generator 118 into a current signal.

The signal generator 118 outputs the voltage signal (not shown). This voltage signal is converted into a current signal by the voltage-current converter 116, and is then supplied to the first laser light source 112 via the amplifier 114. In the first laser light source 112, a repetition period of the pulses of the first laser beam L11 is determined based on the current signal.

The photodiode 122 receives a part of the first laser beam L11 emitted from the first laser light source 112 and outputs, for example, a current signal. The current signal is converted into a voltage signal by a current-voltage converter (not shown), and is input to the signal processor 15 as a laser detection signal S1. The timing of emission of the first laser beam L11 is detected based on the voltage signal input thereto. Note that it may be arranged that a phototransistor or a microphone is used instead of the photodiode 122. The microphone detects an impact sound generated when the target 10 is irradiated with the first laser beam L11. Thus, similarly to the case of the photodiode 122, it is possible to detect the emission timing of the first laser beam L11.

Note that the pulsed laser irradiation unit 11 may be, for example, a circuit configured with discrete components, an integrated circuit, or a circuit in which both of them are mixed.

### 2.2. Vibration Detector

As described above, the vibration detector 13 illustrated in FIG. 1 detects the vibration VB of the surface generated in the target 10 and outputs the light reception signal S2 including the modulation signal and the surface vibration signal. As the vibration detector 13, for example, a laser interferometer disclosed in JP-A-2022-38156 is preferably used. Since the laser interferometer includes the light modulator using the vibrator, the laser interferometer contributes to reduction in size, weight, and power consumption of the vibration detector 13.

Examples of the light modulator 132 using the vibrator 130 include a light modulator disclosed in JP-A-2022-38156. Examples of the vibrator 130 include a quartz crystal vibrator, a silicon vibrator, and a ceramic vibrator. Further, the quartz crystal vibrator may be an AT vibrator, a tuning fork type vibrator, or another vibrator. These vibrators are vibrators that utilize a mechanical resonance phenomenon, and are therefore high in Q-value and can easily achieve stabilization of a natural frequency. Therefore, the S/N ratio (signal-to-noise ratio) of the modulation signal provided to the second laser beam L12 can easily be increased. Further, by using a vibrator high in Q-value as the vibrator 130, the S/N ratio of the reference signal Ss generated by the light modulator 132 can also be increased, and the S/N ratio of various signals based on the reference signal Ss can also be increased.

Examples of the second laser light source 134 include a laser light source disclosed in JP-A-2022-38156. Among them, by using a semiconductor laser such as a vertical cavity surface emitting laser (VCSEL), a further reduction in size of the vibration detector 13 is achieved.

The photodiode 136 (photodetector) receives interference light of the reference light (the second laser beam L12 having passed through the light modulator 132) and the object light (the second laser beam L12 having passed through the target 10), and outputs the light reception signal S2.

The light modulator 132 provides the modulation signal to the second laser beam L12 using the vibrator 130.

Further, as described above, the light modulator 132 includes the vibrator oscillation circuit that generates the reference signal Ss using the vibrator 130 as a signal source (vibration source). Examples of the vibrator oscillation circuit include an inverter type oscillation circuit and a Colpitts type oscillation circuit. These oscillation circuits can generate the reference signal Ss high in frequency stability by using the vibrator 130 high in Q-value of the mechanical resonance.

Further, by using the vibrator 130 as a signal source, the power required to generate the reference signal Ss can be reduced, which also makes a contribution to a reduction in power consumption of the vibration detector 13.

Note that “using the vibrator 130 as a signal source” means that the vibrator 130 is vibrated and an electric signal having a predetermined frequency generated based on that vibration is used.

Based on the laser detection signal S1, the light reception signal S2, and the reference signal Ss, the signal processor 15 calculates the elapsed time Δt from when the first laser beam L11 is emitted to when the vibration VB is detected.

For example, and a preprocessor a demodulator disclosed in JP-A-2022-38156 can be applied to the signal processor 15. The preprocessor performs preprocessing on the light reception signal S2 based on the reference signal Ss, and the demodulator demodulates the surface vibration signal from a signal on which the preprocessing has been performed based on the reference signal Ss.

When the ultrasonic wave US generated by the irradiation with the first laser beam L11 is reflected by the flaw def illustrated in FIG. 1, the vibration VB is induced on the surface of the target 10. With the vibration VB, the displacement of the surface of the target 10 and the change in the displacement speed occur. The signal processor 15 detects the vibration VB by capturing the displacement and the change in the displacement speed. Then, the signal processor 15 measures the elapsed time Δt from when the first laser beam L11 is emitted to when the vibration VB is detected. The elapsed time Δt reflects a propagation distance from when the ultrasonic wave US is generated to when the ultrasonic wave US is reflected by the flaw def and then reaches the surface. The signal processor 15 can accurately measure the elapsed time Δt by using the reference signal Ss as a time reference. Note that the elapsed time Δt can be calculated by, for example, counting the number of pulses of the reference signal Ss. In addition, by detecting the vibration VB based on the displacement or the displacement speed of the surface of the target 10, the vibration VB can be accurately detected. As a result, the inspection accuracy of the target 10 can be improved.

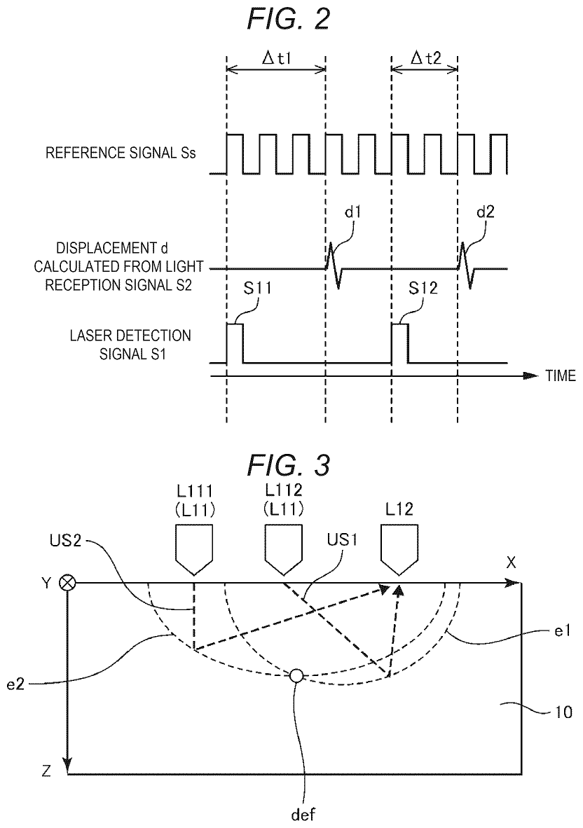

FIG. 2 is a timing chart illustrating an example of the reference signal Ss to be input to the signal processor 15, the displacement d calculated from the light reception signal S2, and the laser detection signal S1.

Each signal processing of the displacement d and the laser detection signal S1 illustrated in FIG. 2 is performed based on the reference signal Ss. Specifically, for example, the signal processor 15 measures, based on the reference signal Ss, an elapsed time Δt1 from a rising edge (timing of emission of the first laser beam L11) of a pulse S11 of the laser detection signal S1 illustrated in FIG. 2 to when a displacement d1 is detected. Similarly, an elapsed time Δt2 from a rising edge (the timing of emission of the first laser beam L11) of a pulse S12 to when a displacement d2 is detected is measured based on the reference signal Ss. Accordingly, the elapsed times Δt1, Δt2 can be accurately measured.

Further, in the present embodiment, the vibration of the vibrator 130 is used for the light modulation, the demodulation of the surface vibration signal, and the measurement of the elapsed time Δt, and accordingly, the reduction in the number of components is achieved.

### 2.3. Flaw Detector

The flaw detector 16 detects the flaw def contained in the target 10 based on the measurement result of the elapsed time Δt by the signal processor 15.

When the target 10 is irradiated with the first laser beam L11 at different positions, a difference between the elapsed time Δt1 and the elapsed time Δt2 shown in FIG. 2 reflects a relationship between the irradiation positions and the position of the flaw def shown in FIG. 1. Therefore, the position of the flaw def can be specified by irradiating the target 10 with the first laser beam L11 while changing the irradiation position and measuring the elapsed time Δt. A specific example will hereinafter be described.

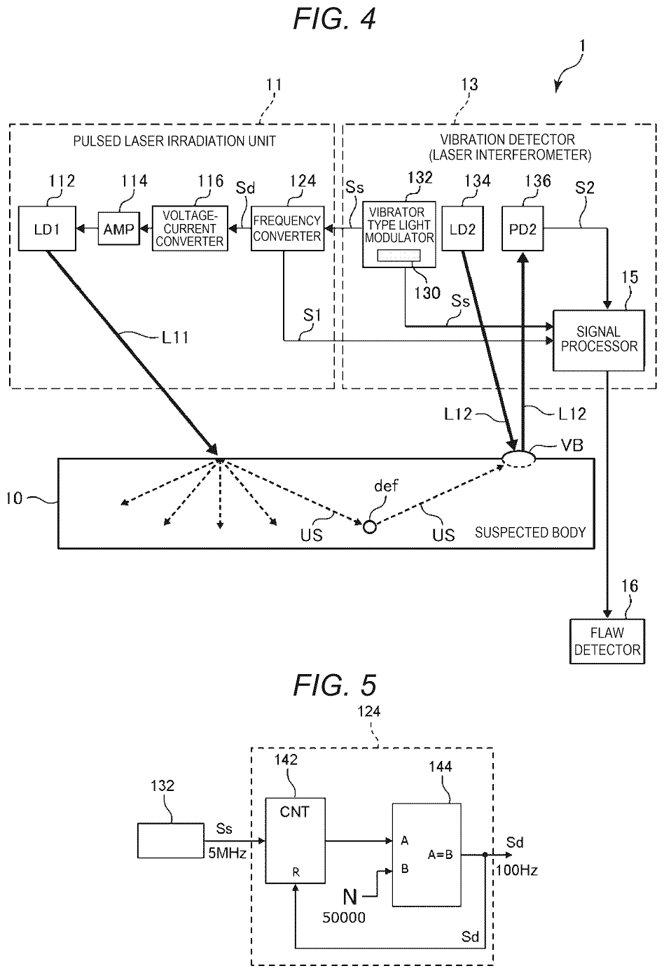

FIG. 3 is a schematic diagram illustrating propagation of ultrasonic waves US1, US2 induced by the first laser beams L111, L112 with which the target 10 is irradiated at two different locations, assuming two axes orthogonal to each other in the surface of the target 10 as an X axis and a Y axis, and an axis in the depth direction as a Z axis. When the target 10 is irradiated with the first laser beam L111, the ultrasonic wave US1 propagates along a large number of trajectories including the illustrated trajectory. Then, a part thereof is reflected by the flaw def and then reaches the surface. The ultrasonic wave US1 that has reached the surface is detected by the second laser beam L12 as a displacement (vibration) of the surface, for example. Similarly, the first laser beam L112 induces the ultrasonic wave US2 propagating along a large number of trajectories including the illustrated trajectory. Then, a part thereof is reflected by the flaw def and then reaches the surface. The ultrasonic wave US2 that has reached the surface is detected by the second laser beam L12 as a displacement (vibration) of the surface, for example.

FIG. 2 is a diagram illustrating an example of waveforms of the displacement d1 derived from the ultrasonic wave US1 reflected by the flaw def and the displacement d2 derived from the ultrasonic wave US2 reflected by the flaw def. Since the irradiation positions with the first laser beams L111, L112 are different from each other, assuming the elapsed times Δt until the displacements d1, d2 are detected as Δt1, Δt2, these are also different from each other. Therefore, the flaw detector 16 may have a function of determining that the flaw def exists when, for example, the elapsed time Δt is equal to or less than a reference value for the elapsed time Δt set in advance based on the reference value.

Meanwhile, the propagation speeds of the ultrasonic waves US1, US2 can be acquired in advance based on the material or the like of the target 10 or by actual measurement. Therefore, the propagation distances of the ultrasonic waves US1, US2 can be calculated from the elapsed times Δt1, Δt2 and the propagation speeds. When the ultrasonic wave US1 propagates in the calculated propagation distance, it results in that the flaw def exists somewhere on the ellipse e1 shown in FIG. 3. Similarly, when the ultrasonic wave US2 propagates in the calculated propagation distance, it also results in that the flaw def exists somewhere on the ellipse e2 shown in FIG. 3. Based on this principle, the position of the flaw def in FIG. 3 can be identified by irradiating the target 10 at three or more irradiation positions with the first laser beam L11.

Since the position of the reflection point is reflected on the elapsed time Δt, the flaw detector 16 detects the presence or absence of the flaw def and identifies the position of the flaw def based on the above principle. This makes it possible to nondestructively inspect the target 10. Note that the distance between the laser ultrasonic inspection apparatus 1 and the target 10 may be measured in advance and used for the position identification. Further, the laser ultrasonic inspection apparatus 1 may include a distance measuring unit described later for measuring the distance.

Note that examples of the constituent material of the target 10 include concrete, metal, resin, ceramics, and glass. Further, examples of the flaw def include a void, a crack, exfoliation, an interface, a foreign matter, and a modified portion.

Further, the functions of the signal processor 15 and the flaw detector 16 are implemented by hardware including, for example, a CPU, a memory, and an interface. Examples of such hardware include a microcomputer. The CPU is an abbreviation for Central Processing Unit. Examples of the memory include any nonvolatile storage elements (ROM), any volatile storage elements (RAM), and a detachable external storage element. Examples of the interface include a digital input output port such as a universal serial bus (USB). Each of the functions of the signal processor 15 and the flaw detector 16 is realized by the CPU executing a program loaded in advance in the memory. Note that instead of or in combination with a method in which the CPU executes the program to realize the functions described above, a method in which hardware such as a field programmable gate array (FPGA), an application specific integrated circuit (ASIC), other integrated circuits, or discrete components realizes the functions described above may be used.

### 3. Second Embodiment

Then, a laser ultrasonic inspection apparatus according to a second embodiment will be described.

FIG. 4 is a block diagram showing a general configuration of the laser ultrasonic inspection apparatus according to the second embodiment.

The second embodiment will hereinafter be described, and in the following description, differences from the first embodiment will mainly be described, and the descriptions of substantially the same matters will be omitted. Note that in FIG. 4, elements substantially the same as those in the first embodiment are denoted by the same reference numerals.

The laser ultrasonic inspection apparatus 1 according to the second embodiment is substantially the same as the laser ultrasonic inspection apparatus 1 according to the first embodiment except that the signal generator 118 is omitted in the pulsed laser irradiation unit 11 and the reference signal Ss output from the light modulator 132 is arranged to be supplied to the pulsed laser irradiation unit 11 instead.

The laser ultrasonic inspection apparatus 1 illustrated in FIG. 4 includes the pulsed laser irradiation unit 11, the vibration detector 13 (laser interferometer), and the flaw detector 16.

The pulsed laser irradiation unit 11 illustrated in FIG. 4 includes the first laser light source 112, the amplifier 114, the voltage-current converter 116, and a frequency converter 124. In the pulsed laser irradiation unit 11 illustrated in FIG. 4, the signal generator 118 and the photodiode 122 are omitted from the pulsed laser irradiation unit 11 illustrated in FIG. 1, and the frequency converter 124 is provided instead.

The frequency converter 124 converts the frequency of the reference signal Ss output from the light modulator 132 to generate the pulse control signal Sd. The pulse control signal Sd controls the repetition period of the first laser beam L11 emitted by the first laser light source 112. The frequency converter 124 includes, for example, a frequency divider circuit that divides the frequency of the reference signal Ss by n, an n-ary counter, and so on. The character n represents a positive integer.

FIG. 5 is an example of a circuit diagram of the frequency converter 124 including the n-ary counter.

The frequency converter 124 illustrated in FIG. 5 includes a first circuit 142 and a second circuit 144.

The reference signal Ss output from the light modulator 132 is input to the first circuit 142. The first circuit 142 has a function of counting the pulses of the reference signal Ss and then outputting the count value. Further, the pulse control signal Sd output from the second circuit is input as a reset signal R. The first circuit 142 has a function of resetting the count value to zero when the reset signal R is input.

The count value and a base number N are input to the second circuit 144. The base number N is set in accordance with, for example, a target repetition frequency of the first laser beam L11. The second circuit 144 has a function of outputting a pulse when A=B, defining the count value as A and the base number N as B. This pulse serves as the pulse control signal Sd. As a specific example, there can be cited an example in which when the frequency of the reference signal Ss is 5 MHz and the base number N is equal to 50000, the pulse of the pulse control signal Sd is output when the count value becomes 50000. In this case, the frequency of the pulse control signal Sd is down-converted to 100 Hz.

The pulse control signal Sd thus generated is supplied to the first laser light source 112 via the voltage-current converter 116 and the amplifier 114. In the first laser light source 112, the repetition period of the first laser beam L11 as a pulsed beam is set based on the pulse control signal Sd. The pulse control signal Sd is also generated based on the reference signal Ss. Therefore, in the second embodiment, the signal generator 118 described above can be omitted. Since the frequency converter 124 as described above can be configured with a relatively small number of components, it becomes possible to further reduce the number of components in the laser ultrasonic inspection apparatus 1.

In the present embodiment, the pulse control signal Sd output from the frequency converter 124 is input to the signal processor 15 as the laser detection signal S1. The signal processor 15 measures the elapsed time Δt from the emission timing of the first laser beam L11 reflected on the laser detection signal S1 to when the vibration VB is detected. Therefore, in the second embodiment, the photodiode 122 described above can be omitted. Further, since the laser detection signal S1 is a signal input to the first laser light source 112, the laser detection signal S1 accurately reflects the timing at which the first laser beam L11 is emitted. Therefore, the elapsed time Δt can more accurately be measured.

Further, in the signal processor 15, the laser detection signal S1 and the reference signal Ss can easily be synchronized, and the elapsed time Δt can more accurately be measured.

The second embodiment described above can also provide substantially the same advantages as provided by the first embodiment.

Further, in the present embodiment, the vibration of the vibrator 130 is used for the light modulation, the demodulation of the surface vibration signal, the measurement of the elapsed time Δt, and the generation of the pulse control signal Sd, and accordingly, a further reduction in the number of components is achieved.

### 4. Third Embodiment

Then, a laser ultrasonic inspection apparatus according to a third embodiment will be described.

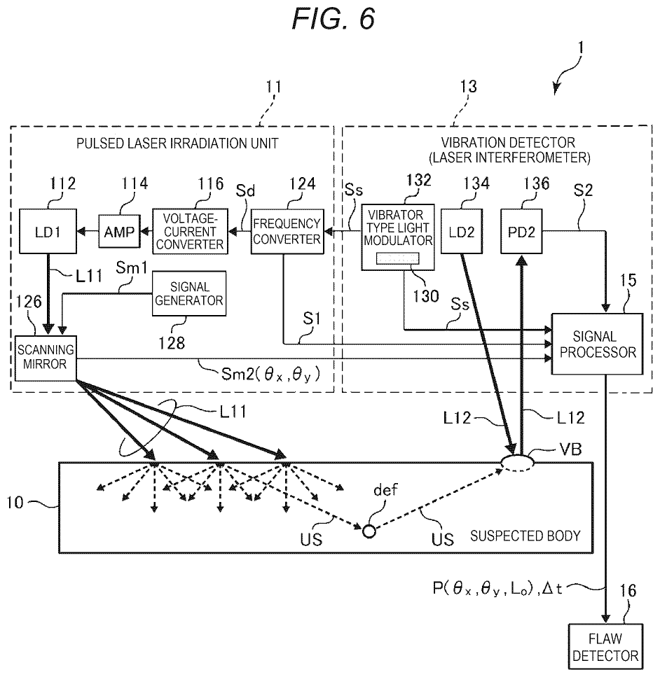

FIG. 6 is a block diagram showing a general configuration of the laser ultrasonic inspection apparatus 1 according to the third embodiment.

The third embodiment will hereinafter be described, and in the following description, differences from the second embodiment will mainly be described, and the descriptions of substantially the same matters will be omitted. Note that in FIG. 6, substantially the same configurations as those of the second embodiment are denoted by the same reference numerals.

The laser ultrasonic inspection apparatus 1 according to the third embodiment is substantially the same as the laser ultrasonic inspection apparatus 1 according to the second embodiment except that a scanning mirror 126 and a signal generator 128 are added in the pulsed laser irradiation unit 11.

The pulsed laser irradiation unit 11 illustrated in FIG. 6 includes the first laser light source 112, the amplifier 114, the voltage-current converter 116, the frequency converter 124, the scanning mirror 126, and the signal generator 128.

The scanning mirror 126 changes a light path of the first laser beam L11 emitted from the first laser light source 112. Accordingly, the target 10 is scanned with the irradiation position with the first laser beam L11. As a result, the position of the flaw def can more easily be identified. Examples of the scanning mirror 126 include a micro electro mechanical systems (MEMS) scanner and a galvano scanner. These scanning mirrors 126 change a reflection angle of the first laser beam L11 by changing an angle of a reflecting mirror.

Among these, a MEMS mirror is preferably used. According to the MEMS mirror, it is easy to reduce the size, weight, and power consumption of the scanning mirror 126. The operation method of the MEMS mirror is not particularly limited, and examples thereof include an electrostatic method, a piezoelectric method, and an electromagnetic method.

The operation mode of the MEMS mirror includes a resonance mode and a non-resonance mode. The non-resonance mode is preferably used out of these modes. In the non-resonance mode, the target 10 can be irradiated with the first laser beam L11 at any positions in accordance with a mirror drive signal Sm1 input to the MEMS mirror.

Further, the scanning type of the scanning mirror 126 may be a one-dimensional type or a two-dimensional type. The two-dimensional type scanning mirror 126 has two rotary shafts, and changes the reflection angle of the first laser beam L11 by swinging the reflecting mirror around the rotary shafts.

The signal generator 128 supplies the mirror drive signal Sm1 toward the scanning mirror 126. In the case of the two-dimensional scanning mirror 126, the posture of the reflecting mirror is represented by inclination angles (θx,θy). The signal generator 128 generates the mirror drive signal Sm1 for driving the two rotary shafts so that the inclination angles (θx,θy) become target values.

The scanning mirror 126 outputs a mirror posture signal Sm2 toward the signal processor 15. The mirror posture signal Sm2 includes information of the inclination angles (θx,θy) of the reflecting mirror. The signal processor 15 can acquire the elapsed time Δt from the emission timing of the first laser beam L11 to when the vibration VB is detected for each of the inclination angles (θx,θy). Note that the mirror posture signal Sm2 input to the signal processor 15 is, for example, an output signal of an angle sensor (not illustrated) provided to the scanning mirror 126.

Note that the signal processor 15 may store a distance Lo between the laser ultrasonic inspection apparatus 1 and the target 10. The distance Lo may be a value measured in advance, or may be a value measured by a distance measuring unit (not illustrated) provided to the laser ultrasonic inspection apparatus 1. The signal processor 15 can determine the value of the irradiation position P(θx,θy,Lo) with the first laser beam L11 based on the inclination angles (θx,θy) of the reflecting mirror and the distance Lo. The value of the irradiation position P(θx,θy,Lo) thus determined and the value of the elapsed time Δt thus measured are input to the flaw detector 16.

Note that examples of the distance measuring unit include a ranging sensor of a time of flight (ToF) method and a ranging sensor of a frequency modulated continuous wave (FMCW) method.

The flaw detector 16 associates the irradiation position P(θx,θy,Lo) with the elapsed time Δt. Then, the flaw detector 16 generates a data set of the position of the flaw def and the elapsed time Δt from these values. Since this data set is point group data, by using, for example, an image obtained by imaging the target 10 and the point group data, image data in which a position in the image and the elapsed time Δt corresponding to that position are associated with each other can be generated. This image data visually represents the length distribution of the elapsed time Δt, and thus makes a contribution to assisting in understanding the distribution state of the flaw def.

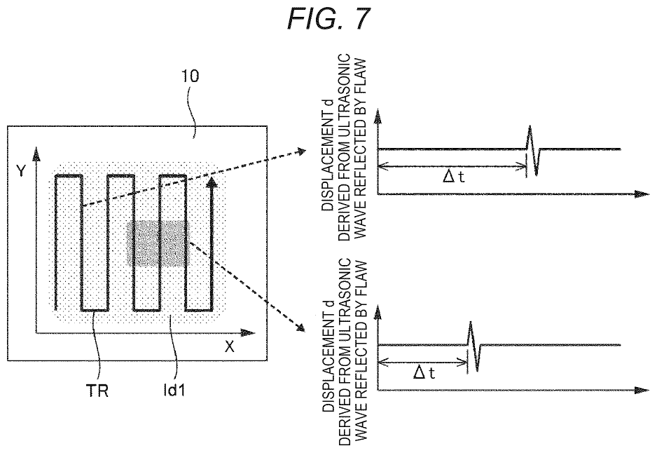

FIG. 7 is a diagram showing an example of a scanning trajectory TR of the irradiation position with the first laser beam L11 and an example of image data Id1 obtained by replacing the length of the elapsed time Δt at each position with a color density and mapping the color density, in the orthogonal coordinate system configured with the X axis and the Y axis set in the target 10. Further, FIG. 7 also illustrates an example of the waveform of the displacement d acquired for two locations different in color density in the image data Id1.

The scanning trajectory TR illustrated in FIG. 7 is a trajectory when the irradiation position is shifted in the X-axis direction while being reciprocated in the Y-axis direction. Further, in the image data Id1 illustrated in FIG. 7, the color density is low when the elapsed time Δt is relatively long, and the color density is high when the elapsed time Δt is relatively short. By creating such image data Id1, the position of the flaw def can visually be indicated. The image data Id1 may be displayed by any method. For example, it may be arranged that the image is displayed on a monitor (not shown) or it may be arranged that the image is projected onto the target 10.

Note that in the present embodiment, scanning with the irradiation position with the first laser beam L11 is performed, but scanning with the irradiation position with the second laser beam L12 may be performed, or scanning with both may be performed.

The third embodiment described above can also provide substantially the same advantages as provided by the second embodiment.

### 5. Fourth Embodiment

Then, a laser ultrasonic inspection apparatus according to a fourth embodiment will be described.

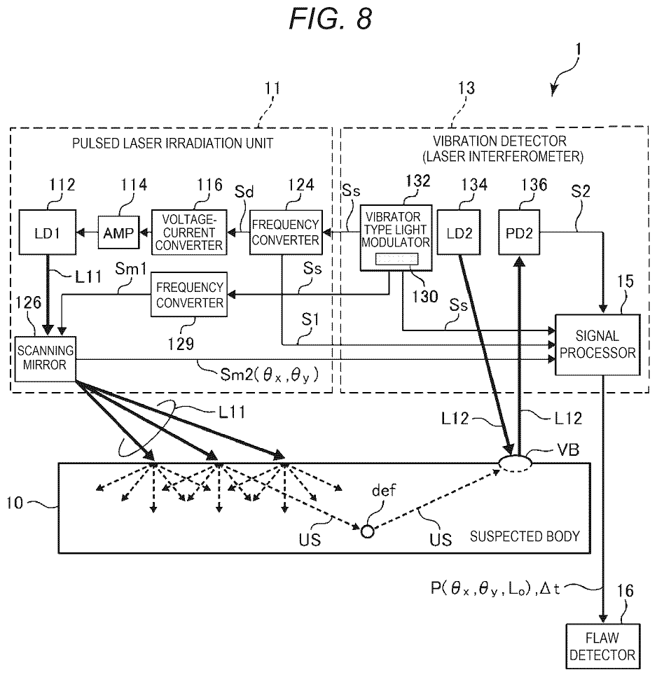

FIG. 8 is a block diagram showing a general configuration of the laser ultrasonic inspection apparatus 1 according to the fourth embodiment.

The fourth embodiment will hereinafter be described, and in the following description, differences from the third embodiment will mainly be described, and the descriptions of substantially the same matters will be omitted. Note that in FIG. 8, substantially the same configurations as those of the third embodiment are denoted by the same reference numerals.

The laser ultrasonic inspection apparatus 1 according to the fourth embodiment is substantially the same as the laser ultrasonic inspection apparatus 1 according to the third embodiment except that a frequency converter 129 is provided instead of the signal generator 128.

The pulsed laser irradiation unit 11 illustrated in FIG. 8 includes the first laser light source 112, the amplifier 114, the voltage-current converter 116, the frequency converter 124, the scanning mirror 126, and the frequency converter 129.

The frequency converter 129 converts the frequency of the reference signal Ss output from the vibrator oscillation circuit of the light modulator 132 into a target frequency, that is, the operating frequency of the scanning mirror 126. Accordingly, the frequency converter 129 generates the mirror drive signal Sm1. The frequency converter 129 includes, for example, a frequency divider circuit that divides the frequency of the mirror drive signal Sm1 by n. The character n represents a positive integer. An example of the frequency divider circuit is an n-ary counter shown in FIG. 5. Specifically, in the n-ary counter shown in FIG. 5, by setting the base number N to 10,000,000, the frequency of the mirror drive signal Sm1 output instead of the pulse control signal Sd shown in FIG. 5 can be down-converted to 0.5 Hz.

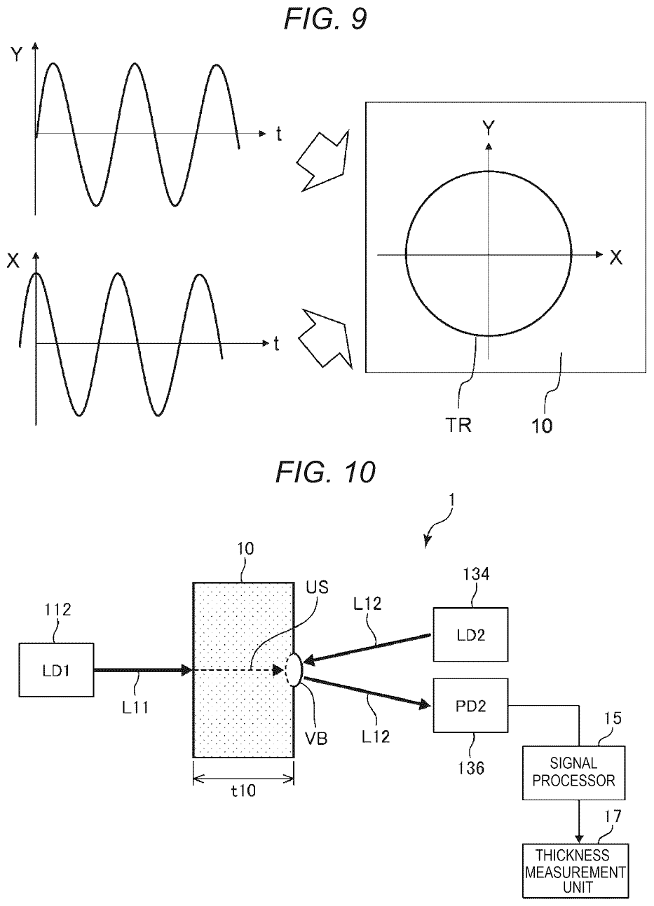

In the case of the two-dimensional scanning mirror 126, the frequency converter 129 generates the mirror drive signal Sm1 for driving the two rotary shafts so that the inclination angles (θx,θy) become target values. For example, when the frequency of the mirror drive signal Sm1 is 0.5 Hz and the frequency of the pulse control signal Sd is 100 Hz, the scanning mirror 126 reflects 20 pulses of the first laser beam L11 while the inclination angle θy makes a single stroke. On this occasion, by shifting the phase of the signal for reciprocating the inclination angle θx (the signal for making a vibration in the X-axis direction shown in FIG. 9) by 90° from the phase of the signal for reciprocating the inclination angle θy (the signal for making a vibration in the Y-axis direction shown in FIG. 9), the scanning trajectory of the first laser beam L11 reflected by the scanning mirror 126 becomes a trajectory drawing a circle like the scanning trajectory TR shown in FIG. 9. Then, while the inclination angle θx makes a single stroke, the scanning mirror 126 reflects the 20 pulses of the first laser beam L11.

FIG. 9 is a diagram illustrating an example of a scanning trajectory TR of the irradiation position with the first laser beam L11 in the orthogonal coordinate system configured with the X axis and the Y axis set in the target 10.

The present embodiment uses the mirror drive signal Sm1 generated using the vibration of the vibrator 130. When the mirror drive signal Sm1 is input to the scanning mirror 126, the scanning trajectory TR of the irradiation position with the first laser beam L11 becomes a trajectory drawing a circle as illustrated in FIG. 9. Accordingly, the surface of the target 10 can be planarly scanned with the first laser beam L11.

Note that in the present embodiment, the mirror posture signal Sm2 input to the signal processor 15 is, for example, an output signal of an angle sensor (not illustrated) provided to the scanning mirror 126.

The fourth embodiment described above can also provide substantially the same advantages as provided by the third embodiment.

Further, in the present embodiment, the vibration of the vibrator 130 is used for the light modulation, the demodulation of the surface vibration signal, the measurement of the elapsed time Δt, the generation of the pulse control signal Sd, and the generation of the mirror drive signal Sm1, and accordingly, a further reduction in the number of components is achieved.

### 6. Fifth Embodiment

Then, a laser ultrasonic inspection apparatus according to a fifth embodiment will be described.

FIG. 10 is a schematic diagram showing a general configuration of the laser ultrasonic inspection apparatus 1 according to the fifth embodiment.

The fifth embodiment will hereinafter be described, and in the following description, differences from the first embodiment will mainly be described, and the descriptions of substantially the same matters will be omitted. Note that in FIG. 10, substantially the same configurations as those of the first embodiment are denoted by the same reference numerals.

The laser ultrasonic inspection apparatus 1 according to the fifth embodiment is substantially the same as the laser ultrasonic inspection apparatus 1 according to the first embodiment except that the laser ultrasonic inspection apparatus 1 is configured to inspect the thickness of the target 10.

The laser ultrasonic inspection apparatus 1 illustrated in FIG. 10 includes the signal processor 15 and a thickness meter 17 coupled thereto. In the laser ultrasonic inspection apparatus 1 illustrated in FIG. 10, one surface of the target 10 is irradiated with the first laser beam L11, and the vibration VB induced on the other surface is detected by the second laser beam L12. In this case, the elapsed time Δt from the emission of the first laser beam L11 to when the vibration VB is detected reflects the thickness t10 of the target 10. That is, when the propagation speed of the ultrasonic wave US is denoted by V, the thickness t10 is obtained by the following formula (1).

$$t 10 = V \cdot Δ t \qquad ( 1 )$$

In addition, it may be arranged that the same surface of the target 10 is irradiated with the first laser beam L11 and the second laser beam L12. In this case, the ultrasonic wave US is reflected by a surface opposite to the irradiation surface and returns to the irradiation surface. In this case, the thickness t10 is obtained by the following formula (2).

$$t 10 = V \cdot Δ t / 2 \qquad ( 2 )$$

The calculation of the thickness t10 as described above can be performed in the thickness meter 17 coupled to the signal processor 15. Accordingly, the laser ultrasonic inspection apparatus 1 can non-destructively examine the thickness of the target 10.

The fifth embodiment described above can also provide substantially the same advantages as provided by the first embodiment.

### 7. Sixth Embodiment

Then, a laser ultrasonic inspection apparatus according to a sixth embodiment will be described.

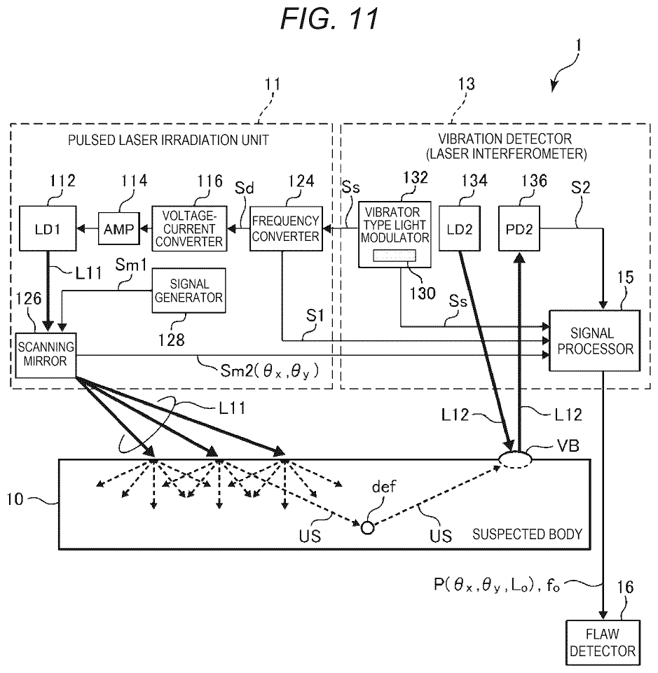

FIG. 11 is a schematic diagram showing a general configuration of the laser ultrasonic inspection apparatus 1 according to the sixth embodiment.

The sixth embodiment will hereinafter be described, and in the following description, differences from the third embodiment will mainly be described, and the descriptions of substantially the same matters will be omitted. Note that in FIG. 11, substantially the same configurations as those of the third embodiment are denoted by the same reference numerals.

The laser ultrasonic inspection apparatus 1 according to the sixth embodiment is substantially the same as the laser ultrasonic inspection apparatus 1 according to the third embodiment except that the signal processor 15 is configured to calculate the frequency of the vibration VB based on the reference signal Ss.

The signal processor 15 illustrated in FIG. 11 captures a displacement and a displacement speed generated on the surface of the target 10 due to the vibration VB. Accordingly, the vibration VB can be detected.

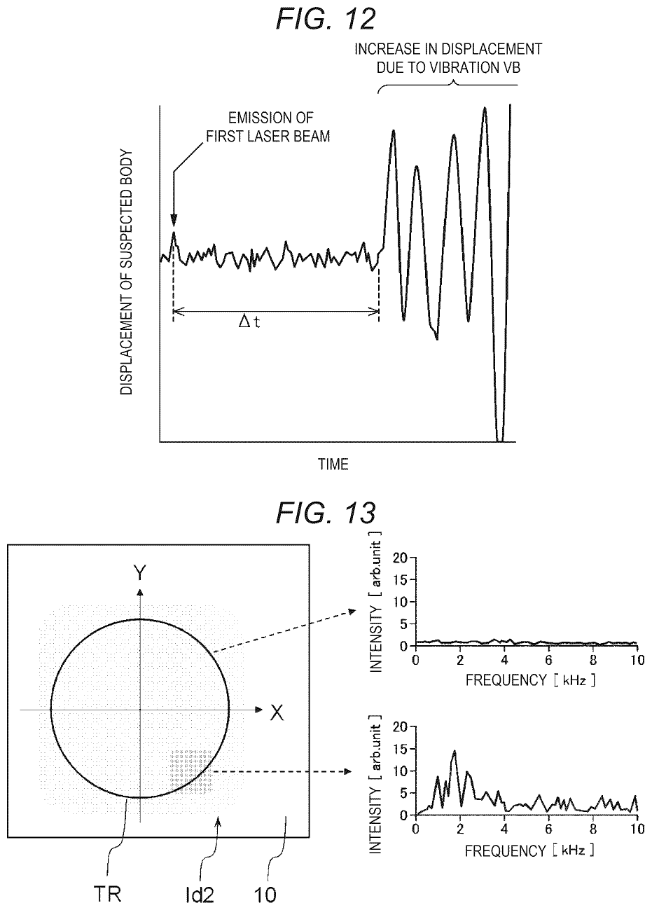

FIG. 12 is a graph showing a waveform of the displacement of the target 10 due to the vibration VB. In FIG. 12, the horizontal axis represents time, and the vertical axis represents the displacement of the target 10.

In the graph shown in FIG. 12, almost no displacement is recognized during the elapsed time Δt from the emission of the first laser beam L11 to when the vibration VB is detected as the displacement of the surface of the target 10. On the other hand, after the elapsed time Δt, the amplitude of the displacement increases. The vibration VB can be detected based on this.

The signal processor 15 illustrated in FIG. 11 has a function of capturing a time waveform of the displacement which increases due to the vibration VB illustrated in FIG. 12 and then performing frequency analysis. Fast Fourier analysis can be used for the frequency analysis. By the frequency analysis, the signal processor 15 generates a frequency analysis result fo. The frequency analysis result fo includes the intensity for each frequency component, that is, resonance frequency information and the like. Since the time waveform of the displacement is generated based on the reference signal Ss, the frequency analysis result fo high in accuracy is obtained.

The value of the irradiation position P(θx,θy,Lo) calculated by the signal processor 15 and the value of the frequency analysis result fo thus generated are input to the flaw detector 16. The flaw detector 16 specifies the state of the flaw def, that is, the presence or absence of a void, a crack, exfoliation, an interface, a foreign matter, a modified portion, or the like, based on the frequency analysis result fo. Specifically, a unique frequency is reflected in the frequency analysis result fo in accordance to the state of the flaw def. This makes it possible to non-destructively inspect the target 10.

Further, the flaw detector 16 may associate the value of the irradiation position P(θx,θy,Lo) with the value of the frequency analysis result fo. In this case, the flaw detector 16 generates a data set of the position of the flaw def and the frequency analysis result fo from these values. Since this data set is point group data, it is possible to generate image data in which a position in the image is associated with the frequency analysis result fo corresponding to the position by using, for example, the image obtained by imaging the target 10 and the point group data. Since the image data visually represents the distribution of the intensity of the frequency analysis result fo, it makes a contribution to supporting the understanding of the distribution state of the flaw def.

FIG. 13 is a diagram illustrating an example of the scanning trajectory TR of the irradiation position with the first laser beam L11 and an example of image data Id2 obtained by replacing the intensity of the frequency analysis result fo at each position with the color density and then mapping the color density, in the orthogonal coordinate system configured with the X axis and the Y axis set in the target 10. Further, FIG. 13 also illustrates an example of the frequency analysis results fo acquired for two locations different in color density in the image data Id2.

In the image data Id2 illustrated in FIG. 13, as an example, when the intensity at a frequency of about 2 kHz is lower than a predetermined threshold value, the color density is low, and when the intensity is equal to or higher than the predetermined threshold value, the color density is high. By creating such image data Id2, the position of the flaw def can visually be indicated.

Note that in the present embodiment, scanning with the irradiation position with the first laser beam L11 is performed, but scanning with the irradiation position with the second laser beam L12 may be performed, or scanning with both may be performed.

The sixth embodiment described above can also provide substantially the same advantages as provided by the third embodiment.

Further, in the present embodiment, the vibration of the vibrator 130 is used for the light modulation, the demodulation of the surface vibration signal, and the generation of the time waveform of the displacement or the displacement speed, and accordingly, the reduction in the number of components is achieved.

### 6. Advantages Provided By Embodiment Described Above

As described above, the laser ultrasonic inspection apparatus 1 according to the embodiment described above includes the first laser light source 112 and the vibration detector 13 (laser interferometer). The first laser light source 112 irradiates the target 10 with the first laser beam L11 as a pulsed beam. The vibration detector 13 uses the second laser beam L12 to detect the vibration VB of the target 10 derived from the ultrasonic waves US induced in the target 10 by the irradiation with the first laser beam L11. Further, the vibration detector 13 includes the second laser light source 134, the light modulator 132, the photodiode 136 (photodetector), and the signal processor 15. The second laser light source 134 irradiates the target 10 with the second laser beam L12. The light modulator 132 modulates the frequency of the second laser beam L12 using the vibrator 130. The photodiode 136 receives the second laser beam L12 having passed through the light modulator 132 and the second laser beam L12 having passed through the target 10, and then outputs the light reception signal S2. The signal processor 15 detects the vibration VB based on the light reception signal S2 and the reference signal Ss, and measures, based on the reference signal Ss, the elapsed time Δt from when the first laser light source 112 emits the first laser beam L11 to when the vibration VB is detected. Further, the vibrator 130 is a signal source of the reference signal Ss.

According to such a configuration, the vibration of the vibrator 130 can be used for the light modulation, the demodulation of the surface vibration signal, and the measurement of the elapsed time Δt. Further, since the presence or absence of the flaw def can be detected based on the elapsed time Δt, the target 10 can be inspected non-destructively. Therefore, it is possible to realize the laser ultrasonic inspection apparatus 1 which is small in the number of components and is easy to reduce in size.

The laser ultrasonic inspection apparatus 1 according to the embodiment described above includes the first laser light source 112 and the vibration detector 13 (laser interferometer). The first laser light source 112 irradiates the target 10 with the first laser beam L11 as a pulsed beam. The vibration detector 13 uses the second laser beam L12 to detect the vibration VB of the target 10 derived from the ultrasonic waves US induced in the target 10 by the irradiation with the first laser beam L11. Further, the vibration detector 13 includes the second laser light source the light modulator 132, the photodiode 136 (photodetector), and the signal processor 15. The second laser light source 134 irradiates the target 10 with the second laser beam L12. The light modulator 132 modulates the frequency of the second laser beam L12 using the vibrator 130. The photodiode 136 receives the second laser beam L12 having passed through the light modulator 132 and the second laser beam L12 having passed through the target 10, and then outputs the light reception signal S2. The signal processor 15 detects the vibration VB based on the light reception signal S2 and the reference signal Ss, and calculates the frequency of the vibration VB based on the reference signal Ss. Further, the vibrator 130 is a signal source of the reference signal Ss.

According to such a configuration, the vibration of the vibrator 130 can be used for the light modulation, the demodulation of the surface vibration signal, and the generation of a time waveform of the displacement or the displacement speed. In addition, the frequency analysis result fo including resonance frequency information and so on can be generated by subjecting the time waveform of the displacement and so on to the frequency analysis. Further, since the presence or absence of the flaw def can be detected based on the frequency analysis result fo, the target 10 can be inspected non-destructively. Therefore, it is possible to realize the laser ultrasonic inspection apparatus 1 which is small in the number of components and is easy to reduce in size.

In the laser ultrasonic inspection apparatus 1 according to the embodiment described above, in the first laser light source 112, the repetition period of the first laser beam L11 as the pulsed beam is set based on the pulse control signal Sd. The pulse control signal Sd is generated based on the reference signal Ss.

According to such a configuration, the vibration of the vibrator 130 can be used for the light modulation, the demodulation of the surface vibration signal, the measurement of the elapsed time Δt, and the generation of the pulse control signal Sd. Therefore, the further reduction of the number of components of the laser ultrasonic inspection apparatus 1 can be achieved.

The laser ultrasonic inspection apparatus 1 according to the embodiment described above includes the scanning mirror 126. The scanning mirror 126 irradiates the target 10 with the first laser beam L11 so as to scan the target 10.

According to such a configuration, it is possible to realize the laser ultrasonic inspection apparatus 1 capable of more easily identifying the position of the flaw def.

In the laser ultrasonic inspection apparatus 1 according to the embodiment, the scanning mirror 126 sets the timing of scanning with the first laser beam L11 based on the reference signal Ss.

According to such a configuration, the vibration of the vibrator 130 can be used for the light modulation, the demodulation of the surface vibration signal, the measurement of the elapsed time Δt, the generation of the pulse control signal Sd, and the generation of the mirror drive signal Sm1. Therefore, the further reduction of the number of components of the laser ultrasonic inspection apparatus 1 can be achieved.

In the laser ultrasonic inspection apparatus 1 according to the embodiment described above, the signal processor 15 detects the vibration VB by calculating the displacement or the displacement speed of the surface of the target 10 from the light reception signal S2.

According to such a configuration, since the vibration VB can be detected based on the displacement or the displacement speed of the surface of the target 10, the vibration VB can accurately be detected. As a result, the measurement accuracy of the elapsed time Δt is also improved, and the inspection accuracy of the target 10 is finally improved.

The laser ultrasonic inspection apparatus 1 according to the embodiment includes the flaw detector 16. The flaw detector 16 detects the flaw def contained in the target 10 based on the measurement result of the elapsed time Δt.

According to such a configuration, the inspection of the target 10 based on the presence or absence and the position of the flaw def can be performed in a non-destructive manner.

The laser ultrasonic inspection apparatus 1 according to the embodiment described above includes the thickness meter 17. The thickness meter 17 measures the thickness of the target 10 based on the measurement result of the elapsed time Δt.

According to such a configuration, the thickness of the target 10 can be inspected in a non-destructive manner.

The laser ultrasonic inspection apparatus 1 according to the embodiment described above includes the flaw detector 16. The flaw detector 16 detects the flaw def contained in the target 10 based on the analysis result of the frequency of the vibration VB.

According to such a configuration, it is possible to non-destructively inspect the target 10 based on the frequency analysis result fo.

Although the laser ultrasonic inspection apparatus according to the present disclosure has been described above based on the illustrated embodiments, the present disclosure is not limited thereto.

For example, the laser ultrasonic inspection apparatus according to the present disclosure may be what is obtained by replacing each element of the embodiment described above with any element having substantially the same function, or what is obtained by adding any element to the embodiment described above. In addition, the laser ultrasonic inspection apparatus according to the present disclosure may have a configuration obtained by combining two or more of the embodiments described above.

What is claimed is:

1. A laser ultrasonic inspection apparatus comprising:
a first laser light source configured to irradiate a target with a first laser beam as a pulsed beam; and
a laser interferometer configured having a second laser beam to detect a vibration of the target derived from ultrasonic waves induced in the target by irradiation with the first laser beam, wherein
the laser interferometer includes
a second laser light source configured to irradiate the target with the second laser beam,
a light modulator configured to use a vibrator to modulate a frequency of the second laser beam,
a photodetector configured to receive the second laser beam from the light modulator and the second laser beam from the target to output a light reception signal, and
a signal processor configured to detect the vibration based on the light reception signal and a reference signal, and measure, based on the reference signal, an elapsed time from the first laser light source emits the first laser beam to the vibration is detected, and
the vibrator is a signal source of the reference signal.

2. A laser ultrasonic inspection apparatus comprising:
a first laser light source configured to irradiate a target with a first laser beam as a pulsed beam; and
a laser interferometer configured to use a second laser beam to detect a vibration of the target derived from ultrasonic waves induced in the target by irradiation with the first laser beam, wherein
the laser interferometer includes
a second laser light source configured to irradiate the target with the second laser beam,
a light modulator configured use a vibrator to modulate a frequency of the second laser beam,
a photodetector configured to receive the second laser beam from the light modulator and the second laser beam from the target to output a light reception signal, and
a signal processor configured to detect the vibration based on the light reception signal and a reference signal, and calculate a frequency of the vibration based on the reference signal, and
the vibrator is a signal source of the reference signal.

3. The laser ultrasonic inspection apparatus according to claim 1, wherein
in the first laser light source, a repetition period of the first laser beam as the pulsed beam is set based on a pulse control signal, and
the pulse control signal is generated based on the reference signal.

4. The laser ultrasonic inspection apparatus according to claim 1, further comprising:
a scanning mirror configured to irradiate the target with the first laser beam so as to scan the target.

5. The laser ultrasonic inspection apparatus according to claim 4, wherein
the scanning mirror sets timing of scanning with the first laser beam based on the reference signal.

6. The laser ultrasonic inspection apparatus according to claim 1, wherein
the signal processor detects the vibration by calculating a displacement or a speed of a surface of the target from the light reception signal.

7. The laser ultrasonic inspection apparatus according to claim 1, further comprising:
a flaw detector configured to detect a flaw contained in the target based on the elapsed time.

8. The laser ultrasonic inspection apparatus according to claim 1, further comprising:
a thickness meter configured to measure a thickness of the target based on a the elapsed time.

9. The laser ultrasonic inspection apparatus according to claim 2, wherein
in the first laser light source, a repetition period of the first laser beam as the pulsed beam is set based on a pulse control signal, and
the pulse control signal is generated based on the reference signal.

10. The laser ultrasonic inspection apparatus according to claim 2, further comprising:
a scanning mirror configured to irradiate the target with the first laser beam so as to scan the target.

11. The laser ultrasonic inspection apparatus according to claim 10, wherein
the scanning mirror sets timing of scanning with the first laser beam based on the reference signal.

12. The laser ultrasonic inspection apparatus according to claim 2, wherein
the signal processor detects the vibration by calculating a displacement or a speed of a surface of the target from the light reception signal.

13. The laser ultrasonic inspection apparatus according to claim 2, further comprising:
a flaw detector configured to detect a flaw contained in the target based on a frequency of the vibration.
